(19) United States
(12) Patent Application Publication
(10) Pub. No.: US 2012/0078709 A1
(43) Pub. Date: Mar. 29, 2012

(54) METHOD AND SYSTEM FOR MANAGING ONLINE ADVERTISING OBJECTS USING TEXTUAL METADATA TAGS

(76) Inventors: Carl A. Dunham, Wakefield, RI (US); David Hughes, Manhattan Beach, CA (US); Michael H. Jarvinen, Los Angeles, CA (US); Edward M. Ives, Exeter, RI (US); Sharon Burt, North Kingstown, RI (US)

(21) Appl. No.: 12/888,691

(22) Filed: Sep. 23, 2010

(51) Int. Cl. G06Q 30/00

(52) U.S. Cl. 705/14.42; 705/14.71; 705/14.41

(57) ABSTRACT

A method for managing online advertising placements includes associating a plurality of textual metadata tags with at least one advertising placement, and generating a bid recommendation for the at least one advertising placement associated with the plurality of textual metadata tags.

### FIELD OF THE INVENTION

The present invention is directed to online advertising.

### DISCUSSION OF RELATED ART

Online advertising comes in many forms, including banner ads, “sponsored” keyword search results, and targeted emails. Marketers typically use online advertising in conjunction with more traditional forms of advertising, including print, radio, and television advertising, as well as non-advertising contacts such as telephone contact initiated by the consumer or the marketer, and “natural” (i.e., unpaid) search engine placements.

Marketers seeking to evaluate the effectiveness of their advertising efforts have developed several metrics to measure how frequently an advertisement leads to further interest and ultimately a conversion. A conversion is a desired action, such as purchasing a product or providing an email address to receive more information, taken by a consumer in response to advertising or other contact with the marketer. By assigning a value to conversions (for example, the profit realized on a sale) marketers can compare the value of the conversions associated with a particular advertisement to the price paid to run that advertisement to determine if the advertisement is profitable. This information is valuable in formulating bids for online advertising to appear on search engines such as those offered by GOOGLE, Inc. (Mountain View, Calif.) and the Microsoft Corporation (Redmond, Wash.), among others.

Metadata tags may be used in online computer systems. A metadata tag (“tag”) is typically a non-hierarchical keyword or term assigned to a conceptual object on the system, such as an internet address (URL), an image, a video, other multimedia object, or any other computer object. The tag may provide a description of the item and allows the item to be quickly accessed again by browsing or searching. In systems and methods currently known in the art, tags are generally chosen informally and personally by the item's creator or by its viewers, depending on the system.

### SUMMARY

Marketers involved in online advertising may wish to track the performance and effectiveness of one or more advertising placements. Several metrics have been developed to evaluate the effectiveness of online advertising, for example, conversions-per-impression, conversions-per-click, clicks-per-impression, return on investment (ROI), and others. The metrics may be calculated for individual advertising placements (e.g., a single banner advertisement or a pay-per-click advertisement). Systems are known in the art to manage several thousand (or more) advertising placements, and to generate metrics for those advertising placements, control where those placements are used, and other related functionality.

These metrics may also be calculated for a group of advertising placements (collectively an “ad group” or “campaign”) using mathematical sums, averages, or other functions known in the art. Presently, systems and methods for organizing advertising placements into groups function similarly to folders, in that each advertisement placement is placed into (at most) one advertisement group. Metrics as described above can be calculated for this advertisement group. The systems may also be capable of modifying all placements in an advertisement group with one action applied to the group. All auction-based media, for example, pay-per-click ad placements, in an advertisement group comprising a particular company's advertisements for red widgets may have bid recommendations associated with them by bid recommendation systems known in the art. In these systems, it may be possible, for example, to modify all ad placements in the “red widget” advertisement group by increasing the bid recommendation for each placement by 5% if a greater advertising presence is desired for the group. By specifying an action to be taken with respect to all placements in an entire advertisement group, the placements in that group can be easily managed without the requirement that each placement be individually modified.

The term “ad placement” is used herein to refer to a commercial message directed to actual or potential consumers, as well as the location, position, or context where the advertising object is placed. For example, an ad placement may include a banner advertisement, paid advertisement, sponsored search ad placement, organic search keyword, full or partial URL of Internet content, social media message (e.g., a Twitter “tweet” or Facebook status message), or targeted email.

Systems and methods presently known in the art utilize a “folder”-style approach to organize placements into groups. However, there are drawbacks to this approach. First, each advertising placement can be placed into at most one advertisement group. Thus, only one organizational scheme can be implemented at any given time. For example, in present systems it may be decided that ad groups will be created on the basis of the color of the widget being advertised, and so a group “red widgets” and a group “blue widgets” may be formed. However, once this scheme has been implemented, there is no way to also create groups based on, for example, the age of the advertising placements (e.g., “old ads” and “new ads”) without abandoning the previous color-based scheme. With this inherent limitation of systems in the art, advertising placements can only be grouped, evaluated as a group, or modified as a group across one dimension (in the previous example, widget color). To treat any other set of advertising placements as a group would require they be selected manually or a search performed each time that set of placements must be modified. Either option may be time-consuming, tedious, and prone to error.

Second, systems presently known in the art can only create groups of advertising placements according to user-defined conditions. In other words, logical groups can only be created based on some attribute that is common to the placements in the group at the time the group is created, and that commonality must be readily identifiable to the person creating the group. Similarly, once the group is defined, its membership remains static unless manual changes are made. For example, in systems presently known, there may be no easy way to create a group of “low performing” advertising placements (e.g., those advertising placements having an ROI falling below a certain threshold). A user wishing to do so must either perform a search to identify those placements, or manually move placements between groups, and continuously do so as more data is collected. This quickly becomes unwieldy if not infeasible.

In further illustration of this limitation, to continue a previous example, a user of a system presently found in the art could move all advertising placements in the system to a group called “old ads”, and add new advertising placements to a group called “new ads.” However, this grouping scheme will start to become obsolete from the moment it is created. If, in time, a still newer group of advertising placements is to be added, the user must either move all placements in “new ads” to “old ads”, create a “newer ads” group, or otherwise compensate for the fact that the “new ads” group is no longer new.

There is presently no method or system allowing a user to group advertising placements across several dimensions simultaneously. Such a method or system would be useful for allowing users to define several groups and allow overlap between memberships. All advertising placements satisfying a particular condition (whether the condition is predefined by a user and/or the system, or generated dynamically at the time the group is accessed) could be accessed, evaluated according to real-time or historical metrics, modified, and/or had bid recommendations assigned or modified.

According to one aspect of the present invention, a system and method are provided for associating one or more textual metadata tags with one or more advertising placements. In some embodiments, the tags may be defined by the user and/or may be defined by the system according to some condition. In other embodiments, the tags may be associated with a rule, set of conditions, query, or other definition of what qualifies an advertising placement to be a member of the ad group associated with the tag. When the tag is accessed by the user, the rule may be applied to all advertising placements, and those advertising placements meeting the condition(s) set by the rule may be dynamically associated with the metadata tag. Tags may be applied to individual advertising placements, or may be applied at different levels of the account hierarchy. For example, a tag may be applied to a number of advertising placements in a particular campaign by an marketer, all advertising placements in a given ad group previously defined by a user or the system, and/or all advertising placements associated with a particular marketer.

In accordance with one aspect of the present invention, a method for managing online advertising placements is provided. The method comprises the act of associating a plurality of textual metadata tags with at least one advertising placement in a plurality of advertising placements. The method further comprises an act of generating a bid recommendation for the at least one advertising placement associated with the plurality of textual metadata tags.

In accordance with one embodiment, the method further comprises the act of determining a relative priority of each textual metadata tag in the plurality of textual metadata tags, wherein the act of generating a bid recommendation is performed with reference to the relative priority.

In accordance with another embodiment, the method further comprises an act of permitting the at least one advertising placement to be associated with at most one exclusive textual metadata tag.

In accordance with still another embodiment, the method further comprises an act of calculating a performance metric for the at least one advertising placement, wherein the act of generating a bid recommendation is carried out with reference to the performance metric.

In accordance with yet another embodiment, the method further comprises acts of receiving user input from a user, and forming the user input into at least one textual metadata tag.

In accordance with a further embodiment, the act of forming the user input into at least one textual metadata tag comprises the act of forming, responsive to the user input satisfying at least one predetermined syntax rule, the user input into at least one textual metadata tag.

In accordance with another embodiment, the act of associating the plurality of textual metadata tags with at least one advertising placement in a plurality of advertising placements includes acts of associating at least one selection condition with a textual metadata tag, and associating, responsive to a selection of the textual metadata tag, the textual metadata tag with at least one advertising placement satisfying the selection condition.

In accordance with a further embodiment, the selection condition is a selection query.

In accordance with another embodiment, the bid recommendation is generated based on at least one of the plurality of textual metadata tags.

In accordance with still another embodiment, at least one of the plurality of textual metadata tags indicates a characteristic of the at least one advertising placement.

In accordance with yet another embodiment, at least one of the plurality of textual metadata tags indicates a characteristic of a product advertised by the at least one advertising placement.

In accordance with another embodiment, at least one of the plurality of textual metadata tags indicates a characteristic of a transaction involving a product advertised by the at least one advertising placement.

In accordance with a further embodiment, the characteristic of the transaction includes the advertised price of the product. In accordance with another embodiment, the characteristic of the transaction includes the advertised shipping cost of the product.

In accordance with another embodiment, at least one of the plurality of textual metadata tags indicates a URL of an advertising placement.

In accordance with still another embodiment, the method further comprises an act of receiving at least one of the plurality of textual metadata tags over a distributed computer system.

In accordance with a further embodiment, at least one of the textual metadata tags indicates a search keyword used in a search engine search that resulted in the at least one advertising placement to be displayed. In accordance with another embodiment, the at least one textual metadata tag is generated by a user of the Internet.

According to another aspect of the present invention, a method for managing online advertising placements is provided. The method comprises the act of associating a plurality of textual metadata tags with at least one advertising placement in a plurality of advertising placements. The method also comprises the act of retrieving performance metrics about the plurality of advertising placements. The method also comprises the act of evaluating a performance of the at least one advertising placement associated with the plurality of textual metadata tags.

According to one embodiment, the at least one of the plurality of textual metadata tags indicates a characteristic of the at least one advertising placement.

According to another embodiment, at least one of the plurality of textual metadata tags indicates a characteristic of a product advertised by the at least one advertising placement.

According to still another embodiment, at least one of the plurality of textual metadata tags indicates a characteristic of a transaction involving a product advertised by the at least one advertising placement.

According to a further embodiment, the characteristic of the transaction includes the advertised price of the product. According to another embodiment, the characteristic of the transaction includes the advertised shipping cost of the product.

According to another embodiment, at least one of the plurality of textual metadata tags indicates a URL of an advertising placement.

According to still another embodiment, the method further comprises the act of receiving at least one of the plurality of textual metadata tags over a distributed computer system.

According to a further embodiment, at least one of the textual metadata tags indicates a search keyword used in a search engine search that resulted in the at least one advertising placement to be displayed. According to another embodiment, the at least one textual metadata tag is generated by a user of the Internet.

According to another embodiment, the method further comprises acts of receiving user input from a user, and forming the user input into at least one textual metadata tag.

According to still another embodiment, the act of associating the plurality of textual metadata tags with at least one advertising placement in a plurality of advertising placements includes acts of associating at least one selection condition with a textual metadata tag, and associating, responsive to a selection of the textual metadata tag, the textual metadata tag with at least one advertising placement satisfying the selection condition.

According to yet another embodiment, the method further comprises acts of generating a report on the performance of the at least one advertising placement associated with the plurality of textual metadata tags, and providing the report to a user.

According to another embodiment, the method further comprises the act of determining a relative performance of each of the at least one advertising placements associated with the plurality of textual metadata tags.

According to still another embodiment, the method further comprises acts of receiving user input from a user, and forming the user input into at least one textual metadata tag.

According to a further embodiment, the act of forming the user input into at least one textual metadata tag comprises the act of forming, responsive to the user input satisfying at least one predetermined syntax rule, the user input into at least one textual metadata tag.

According to another aspect of the present invention, a computer-readable medium is provided. The computer-readable medium comprises computer-executable instructions that, when executed on a processor of a server, perform a method for managing online advertising placements. The method comprises the act of associating a plurality of textual metadata tags with at least one advertising placement in a plurality of advertising placements. The method also comprises the act of generating a bid recommendation for the at least one advertising placement associated with the plurality of textual metadata tags.

According to one embodiment, the method further comprises an act of permitting the at least one advertising placement to be associated with at most one exclusive textual metadata tag.

According to another embodiment, the method further comprises an act of calculating a performance metric for the at least one advertising placement, wherein the act of generating a bid recommendation is carried out with reference to the performance metric.

According to still another aspect of the present invention, a system is provided. The system comprises a tag database configured to store a plurality of textual metadata tags and a placement identifier identifying at least one advertising placement associated with the plurality of textual metadata tags. The system also comprises a placement database configured to store information about at least one advertising placement. The system further. The system also comprises a tagging engine configured to generate the plurality of textual metadata tags and store the plurality of textual metadata tags in the tag database.

According to one embodiment, the system further comprises a user interface configured to receive user input.

According to a further embodiment, the user input is text used to generate at least one textual metadata tag.

According to another embodiment, the system further comprises a reporting interface configured to calculate and display performance metrics relating to the plurality of textual metadata tags and the at least one advertising placement.

According to yet another aspect of the present invention, a method for managing online advertising placement is provided. The method comprises the act of evaluating a performance of a first advertising placement. The method also comprises the act of identifying at least one second advertising placement having at least one characteristic in common with the first advertising to placement. The method also comprises the act of associating a textual metadata tag with the second advertising placement.

According to one embodiment, the second advertising placement is of a different format than the first advertising placement.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects of the present invention may be implemented;

FIG. 2A shows an example system for managing online advertising objects using textual metadata tags in accordance with one embodiment of the invention;

FIG. 2B depicts an example physical and logical diagram of the system of FIG. 2A in more detail;

FIG. 3 illustrates an example process for managing online advertising objects using textual metadata tags in accordance with one embodiment of the invention;

FIG. 4 shows a tagging interface in accordance with embodiments of the present invention;

FIG. 5 shows a reporting interface in accordance with embodiments of the present invention;

FIG. 6 shows a rule interface in accordance with embodiments of the present invention; and

FIG. 7 shows a dashboard interface in accordance with embodiments of the present invention.

### DETAILED DESCRIPTION

The aspects disclosed herein, which are consistent with principles of the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to managing online advertising objects using textual metadata tags. However, such a system may also perform other functions. Moreover, the systems described herein may be configured to include or exclude any of the functions discussed herein. Thus, the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

According to various embodiments of the present invention, a system and method are provided for managing online advertising objects using textual metadata tags. Tags may be created according to user input received through an interface, and/or according to system-defined or user-defined rules. The tags may identify one or more attributes, characteristics, or performance levels of the online advertising placements, including ad content; the medium where the ad will be placed; the account with which the account is associated; the current or historical performance of the ad placement according to one or more performance metrics; or other data.

Rules may also be defined to allow dynamic tagging, wherein all ad placements satisfying the rule condition at the time the tag is accessed will be dynamically tagged. In some embodiments, dynamic tagging may be performed on ad placements that satisfied a rule condition at an earlier point in time. For example, a rule may be created to identify those ad placements that had a low profitability a month earlier. When the tag is accessed, all ad placements satisfying that rule may be dynamically tagged.

One or more of these tags may be applied to an ad placement, so that ads satisfying a certain condition can be quickly accessed via the tag. In this manner, tags allow ad placements and related to data to be simultaneously grouped across any number of dimensions.

Bidding tags may also be created, and may be applied to ad placements in a manner that is controlled by different (e.g., stricter) rules than those governing normal tags. For example, in some embodiments, only one bidding tag may be permitted to be associated with any given ad placement at any given time. Such a restriction may avoid unwanted consequences where multiple performances of certain actions, such as generating bid recommendations or otherwise modifying or removing the ad placements, may conflict. By associating those actions to bidding tags, and restricting ad placements to at most one bidding tag at a time, the number of modifying actions performed on a given ad placement can be controlled.

It will be appreciated that the term “bidding tag” as used herein is not limited to tags associated with bidding, but may refer to any tag subject to restrictions on the number of tags that may be associated with a given ad placement. Such restrictions may be useful for tags associated with any action that may modify or delete an ad placement, so that those actions do not conflict with similar actions or other modifying/deleting actions. Such actions may include modifying or generating a bid recommendation, deleting an ad placement, archiving an ad placement, suspending or disabling an ad placement, or other actions taken on ad placements in the art.

One or more of these features may be implemented on one or more computer systems coupled by a network (e.g., the Internet). Example systems upon which various aspects are implemented are discussed in more detail below.

### Computer System

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the invention is not limited to any particular distributed architecture, network, or communication protocol. Furthermore, aspects in accord with the present invention may be implemented as specially-programmed hardware and/or software.

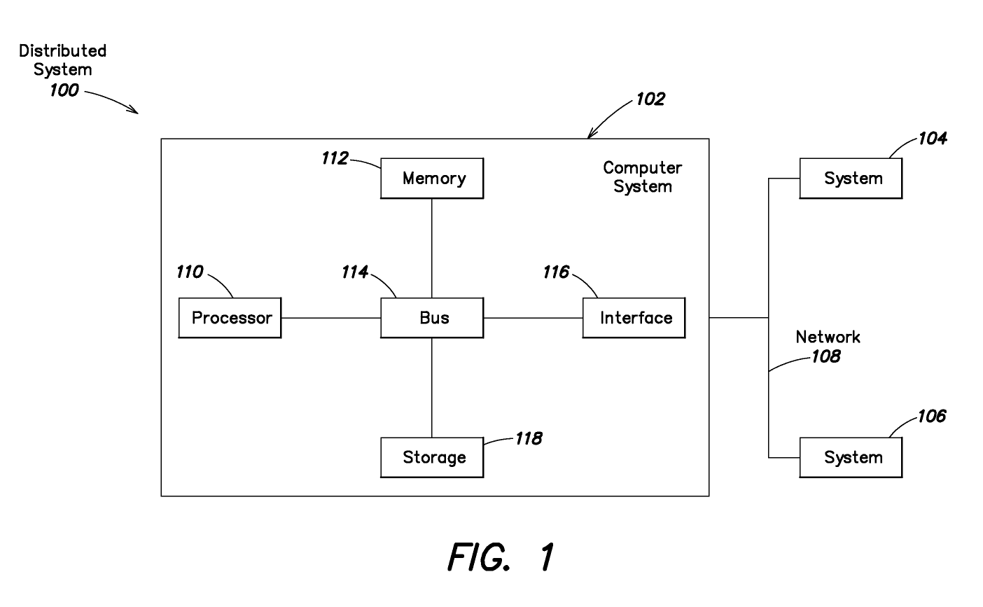

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA HOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including the computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that manipulate data. The processor 110 may be a well-known, commercially available processor such as an Intel Pentium, Intel Atom, Motorola PowerPC, SGI MIPS, Sun UltraSPARC, or Hewlett-Packard PA-RISC processor, or may be any other type of processor or controller as many other processors and controllers are available. As shown, the to processor 110 is connected to other system placements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device. Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), and may include any communication coupling between system placements including specialized or standard computing bus technologies such as IDE, SCSI, PCI and InfiniBand. Thus, the bus 114 enables communications (for example, data and instructions) to be exchanged between system components of the computer system 102.

The computer system 102 also includes one or more interface devices 116 such as input devices, output devices and combination input/output devices. The interface devices 116 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

The storage system 118 may include a computer-readable and -writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, the processor 110 or some other controller may cause data to be read from the nonvolatile recording medium into another memory, such as the memory 112, that allows for faster access to the information by the processor 110 than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and the memory 112, and the invention is not limited thereto.

Further, the invention is not limited to a particular memory system or storage system. Although the computer system 102 is shown by way of example as one type of computer system upon which various aspects and functions in accord with the present invention may be practiced, aspects of the invention are not limited to being implemented on the computer system, shown in FIG. 1. Various aspects and functions in accord with the present invention may be practiced on one or more computers having different architectures or components than that shown in FIG. 1. For instance, the computer system 102 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware placements included in computer system 102. A processor or controller, such as processor 110, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle, Wash.; Oracle Database from Oracle of Redwood Shores, Calif.; and MySQL from Sun Microsystems of Santa Clara, Calif.; or integration software such as WebSphere middleware from IBM of Armonk, N.Y. However, a computer system running, for example, SQL Server may be able to support both aspects in accord with the present invention and databases for sundry applications not within the scope of the invention.

### Example System Architecture

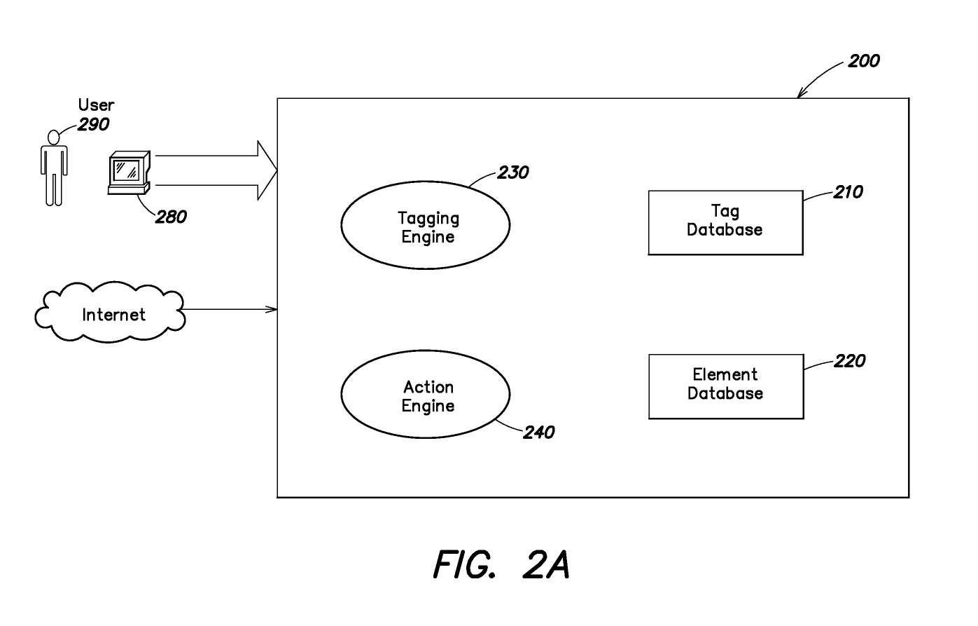

FIG. 2A shows a block diagram of a system 200 for tagging advertising placements (“ad placements”) with textual metadata tags (“tags”). The system 200 includes a tagging engine 230, which may be a microprocessor routine or other software and/or hardware component configured to receive, generate, and/or modify tags. The tagging engine 230 may also, in response to a user selecting one or more ad placements, apply a tag to each selected ad placement. As explained in more detail below, in some embodiments the tagging engine 230 may generate the tag automatically (i.e., with no user interaction). In other embodiments, the tagging engine 230 may be configured to receive input from a user 290, with the input being used to generate the tag. For example, the user 290 may enter text through a user interface 280, with the text being incorporated, in whole or in part, into the tag. In the same manner, the tagging engine 230 may modify or delete an existing tag, either automatically or through interaction with the user 290.

The tagging engine 230 may be configured to store the tags in a tag database 210. The tag database 210 may be a relational database or any other method of storing data known in the art, such as XML, flat file, or spreadsheet. The tag database 210 may store the tags as plain text, or may encode them in binary or other format.

A placement database 220 may be provided for storing ad placements, along with attributes and performance data about the ad placements, for example, performance metrics; the channel, campaign, or account with which the ad placement is associated; and other information. In some embodiments, the placement database 220 may store the actual ad placements themselves. For example, if the ad placement contains text, the text and any necessary formatting may be stored in the placement database 220. If the ad placement contains image, video, or other multimedia data, the binary multimedia data may be stored in the placement database 220. In other embodiments, a pointer, name, or other reference to the ad placement may be stored in the placement database 220. For example, the file name or URL of the ad placement may be stored in the placement database 220. The placement database 220 may also store performance information about the ad placement for a given time period.

An action engine 240 may be provided for performing actions on ad placements associated with one or more particular tags. The action engine 240 may be a microprocessor routine or other software and/or hardware component configured to interact with ad placements or data describing ad placements. Such actions may include modifying the ad placement in some way or generating metrics, bid recommendations, or other data about the ad placements, either individually or as a group.

The user interface 280 is provided to allow the user 290 to interact with the system 200 in several ways. For example, the user interface 280 may allow the user to enter the text making up a tag through a text-entry component such as a physical keyboard, on-screen/“soft” keyboard, mouse, trackball, or other input device. The user interface 280 may also provide for the user 290 to either associate one or more tags directly with one or more ad placements, or to create rules according to which tags may later be dynamically applied to one or more ad placements. The user interface 280 may provide a display to allow the user to view a graphical representation of the current state of the system 200. The user interface 280 may provide further functionality, such as reporting statistics or performance metrics about one or more tags or ad placements.

The tag database 210, placement database 220, tagging engine 230, action engine 240, user interface 280, and other components described herein may be interconnected in a variety of ways and able to interact as described below. These sundry computer systems shown in FIG. 2 each may include one or more computer subsystems. As discussed in regard to FIG. 1, such computer systems may have one or more processors or controllers, memory, and interface devices. In certain embodiments, one or more of the placements depicted as being distinct placements in FIG. 2 may be implemented on the same system. For example, one or more of the tag database 210 and placement database 220 may be implemented on the same system, and may be implemented as different tables within one database. Similarly, the tagging engine 230 and the action engine 240 may be different routines, executable, or subroutines running on the same processor in the system 200. The particular configuration of system 200 depicted in FIG. 2 is used for illustration purposes and it should be appreciated that embodiments of the invention may be practiced in other contexts, as the invention is not limited to a specific number of users or to a specific number or type of systems.

Information may flow between the placements, components, and subsystems of the system 200 using any technique. Such techniques include, for example, passing the information over the network via TCP/IP, passing the information between modules in memory, and passing the information by writing to a file, database, or some other non-volatile storage device. In addition, pointers or other references to information may be transmitted and received in place of, or in addition to, copies of the information. Conversely, the information may be exchanged in place of, or in addition to, copies of the information. Other techniques and protocols for communicating information may be used without departing from the scope of the embodiments described herein.

The terms “tags” (verb), “tagged,” and “tagging” are used herein to refer to the association of one or more tags with one or more ad placements. It is contemplated that this association may be performed in any number of ways. For example, in some embodiments the tag may be stored in a database along with an indicator of which ad placements are associated with it. In other embodiments, the tag may alternately or additionally be “embedded” in the ad placement. As used herein, a tag may be “embedded” in an ad placement in any number of ways. For example, if the ad placement is stored in a file, the characters making up the tag may be inserted into the file, or stored as metadata information with the file, for example, in a companion file associated with the ad placement file. As another example, the ad placement may be stored in XML or other markup format, and the tag may be inserted into the data, for example, as an XML element. It will be appreciated that there are many ways of associating one or more tags with one or more ad placements, and the illustrative examples given here are not intended to limit the scope of this disclosure in any way. Furthermore, any references to a tag 212 being “entered” may include any method by which the tag is associated with one or more ad placements. For example, in addition to a user typing or otherwise inputting text, tags may be entered in other ways. In some embodiments, a user that has indicated a desire to associate a tag 212 with one or more ad placements may be presented with a list of existing tags 212 that can be associated with the ad placements through clicking a user input device (for example, a mouse) or otherwise selecting one or more existing tags displayed to the user.

It is contemplated that tags may be implemented in either a hierarchical or non-hierarchical manner. In a hierarchical approach, the tags may be organized into groups according to a predetermined or user-defined scheme, or organized by channel, campaign, account, or user.

The term “user” is used herein to refer to any person interacting with ad placements through the system 200. For example, users may include potential consumers who encounter an online advertising placement while using a personal computer in their home or office to browse the world wide web. Users may also include system administrators, technicians, or other persons interacting with the system described herein or executing the methods described herein. Furthermore, any acts described herein as being performed by users may also be performed partially or entirely by the system 200, with limited or no input from a human user.

A detailed block view of the system 200 in accordance with the present invention can be seen in FIG. 2B. In several embodiments, the tag database 210 may be configured to store one or more tags 212. One or more tags 212 may be associated in the tag database 210 with one or more ad placements 222 that have been tagged by a user 290 and/or the system 200 (i.e., associated with the particular tag 212). For example, the tag database 210 may store, for each tag 212, one or more placement identifiers that serves as a pointer or reference to an ad placement stored in the placement database 220.

Referring still to FIG. 2B, the tag database 210 may be configured to store the tags 212 for a given ad placement 222 in any number of ways. In some embodiments, the tag database 210 may store each tag 212 for a given ad placement 222 in a different field of the database. In other embodiments, the tag database 210 may store all of the tags for a given ad placement 222 in a single field separated by a delimiting character, for example, “;” (semicolon). To preserve data integrity in such embodiments it would be desirable to treat the delimiting character as a reserved character as described herein. In these embodiments, to add or remove an association between an ad placement 222 and a tag 212 it would be a simple matter of appending text to the tag string or searching and removing a particular substring from the tag string, respectively. In still other embodiments, the tags 212 may be stored in a spreadsheet.

The placement database 220 is provided for storing at least one ad placement 222, along with attributes and performance data about the at least one ad placement 222, for example, the placement database 220 may store performance metrics and/or derived calculations about ad placements 222, such as the conversions-per-impression, conversions-per-click, clicks-per-impression, return on investment (ROI), and other performance measures of the ad placements 222 over time. As another example, the placement database 220 may store information about the channel, campaign, account, or user with which the ad placement 222 is associated.

A “channel” is a conceptual structure that describes the broad category in which the ad placement 222 falls. For example, an ad placement may be categorized in a channel for banner advertisements text links, or popup advertisements on a website. Alternately, an ad placement may be in the “email” channel, the “sponsored search” channel, or the “organic search” (i.e., natural or non-sponsored search) channel Ad placements in different channels may be managed by different systems or methods, in different applications within the same system, or may be managed in the same system. As is discussed below, the present system and method may provide for using the characteristics or performance of ad placements in one channel to be used in determining an action to take on similar ad placements in another channel. The action may include, for example, generating or modifying a bid recommendation.

A “campaign” is a particular strategy deployed on the part of a particular marketer. For example, a particular new product may be the subject of a campaign. Other campaigns may be directed, for example, at particular media outlets, or consumers fitting a certain personal or activity profile.

An “account” represents the marketer or other entity with which the ad placement 222 is associated. In other words, all ad placements 222 deployed by a particular marketer would be associated with the account of that marketer.

It will be appreciated that other organizational schemes and hierarchies are contemplated, and the examples given here are for illustration purposes only. For instance, channels may be further organized into specific vendors within the channel. For example, vendors such as Google AdWords, Yahoo Right Media Exchange, Microsoft Bing may be organized within a “social media” channel. As another example, ad groups organized around a particular aspect of a campaign may be organized within a particular campaign. The placement database 220 may be configurable to store other information, including information that is customizable by the user 290.

Referring still to FIG. 2B, the action engine 240 may be configured to perform various actions on the ad placements 222 tagged by a selected tag 212. The action engine 240 may perform actions by modifying the ad placements 222 stored in the placements database 220 directly, by modifying any other data or metadata stored in the placements database 220 or anywhere else, or by any other technique for modifying data. The actions performed by the action engine 240 may include, for example, generating a report, graph, or chart about some characteristic or historical performance measure of the ad placements 222; downloading information or bid recommendations for those ad placements 222 for backup, offline use, or use on another system; making changes to or entering bid recommendations or bid strategies; assigning an alert when some metric describing the ad placements 222, either alone in aggregate, exceeds or falls below a certain defined threshold; or adding additional tags 212.

The action engine 240 may be configured to perform multiple actions in sequence. In addition, the action engine 240 may be configured to perform a first action, and then perform a second action based on the outcome of the first action. For example, the action engine 240 may perform a first action of calculating the return on investment (ROI) of all ad placements 222 associated with a given tag 212. Calculating the ROI of the ad placements 222 may be useful for identifying how profitable a group of ad placements 222 is, and may influence the user 290 to modify bid recommendations for those ad placements accordingly.

Once the action engine 240 has calculated the ROI of a group of ad placements, it may determine a second action based on the ROI value. For example, if the ROI falls below a certain threshold (meaning the ad placements 222 have not been profitable), then the action engine 240 may be configured to reduce the bid recommendation for those ad placements. If on the other hand the ROI exceeds the threshold, the action engine 240 may increase the bid recommendation for those ad placements. It will be appreciated that the actions described here are provided for illustrative purposes only, and that other actions may be performed by the action engine 240. In some embodiments, the action engine 240 may be configured to perform actions that were defined by the user 290 through an interface element, such as an interactive script designer, rule definition interface, macro, keystroke recorder, or scripting language.

### Exemplary Method

Having described various aspects of a system for managing online advertising objects using textual metadata tags, the operation of such a tagging system is now described.

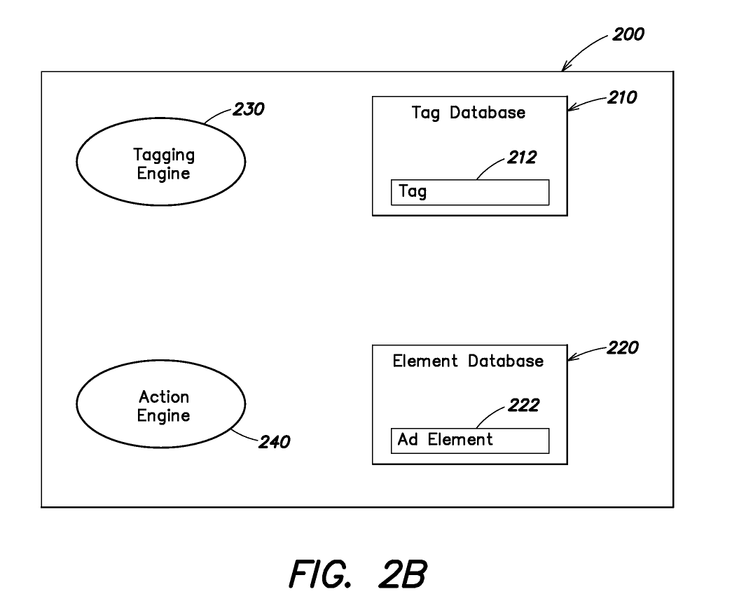

A method according to one embodiment of the invention is described with reference to FIG. 3. As shown in act 310, a tag is generated. The tag may be a textual metadata tag. The tag may be composed of text and may include any alphanumeric or other characters. In some embodiments where reserved characters are used in the structure of the database or have other specialized meanings, tags including those reserved characters may be disallowed. For example, in some embodiments, tags may be prevented from including “ ” (space), “,” (comma), “.” (period), “;” (semicolon), or any other character. In other embodiments, such reserved characters may be allowed, but escape characters (e.g., “/” (slash)) may be inserted before the reserved character to indicate its literal inclusion in the tag. In other embodiments, such reserved characters may be replaced with one or more corresponding replacement characters. For example, if “ ” (space) is considered a reserved character not allowed in a tag, all space characters may be automatically replaced by, for example, “_” (underscore) or “-” (hyphen) prior to the tag being created. In still other embodiments, reserved or unexpected characters may be accommodated according to other data-handling techniques known in the art. In some embodiments, tags may be case-sensitive or case insensitive. In some embodiments, all tags may be converted to a particular standardized format, for example, upper case, lower case, title case, or sentence case.

In some embodiments, tags may be generated solely from text input by a user. In other embodiments, some or all of the tags may be generated according to certain predefined rules. For example, each tag may be prepended with an identifier of the particular user associated with the tag. Thus, if user John Smith were to create a tag by entering the text red_widgets, John Smith's system ID may be appended such that the tag would be, for example, jsmith_redwidgets. This approach may allow several users to create otherwise-identical tags that are distinguished through the addition of prepended text or other modification of the text entered by the user. In other embodiments, tags may be created exactly as entered by the user, but the system may also generate another tag with the user's chosen text prepended with the user's system ID (e.g., create tags redwidgets and jsmith_redwidgets).

Similarly, the system may observe rules that disallow certain reserved tags. The reserved tags may be associated with privileged actions to be performed on all ad placements associated with the reserved tag, so it may be necessary to prevent some users from creating such reserved tags, either intentionally or unintentionally. For example, a reserved tag comprised of the text purge may be used by system administrators to tag all ad placements that should be removed from the system. Because it would be highly undesirable to purge ad placements that the system administrators wish to preserve, in some embodiments the system may disallow some or all users lacking certain administrative privileges from creating particular tags, for example, purge. In other embodiments, the tags that contain particular strings of text may be disallowed. For example, users without administrative rights may be prohibited from creating tags beginning with the text admin_. In other words, where the system allows ad placements associated with the tag admin_purge to be removed from the system, any user may be allowed to create a tag purge, but only some high-level users may be allowed to create the tag admin_purge.

In some embodiments, tags may be created or assigned to ad placements on a per-user basis. In these embodiments, tags created by or associated with a particular user may be accessible or visible to only some subset of the users of the system. Users without administrative privileges may only be able to access and view a list of ad placements associated with that user. Users having administrative privileges may be able to access and view all tags on the system, or all tags associated with certain users. In other embodiments, the set of tags visible to a user may be configurable to some extent by the user.

Other reserved tags may be associated with other privileged actions to be performed on all ad placements associated with the reserved tag. For example, a reserved tag may be used by system administrators to tag all duplicate ad placements. This may allow a further action to be performed on those ad placements, such as removing the duplicate ad placements or manually examining the duplicates to investigate the purpose, if any, for the duplication.

In other embodiments, the system may not strictly enforce any rules regarding reserved tags. That is, naming schemes for tags may be enforced informally through convention agreed upon by users or through processes involving humans, such as supervisory approval or review of all created tags. In these embodiments, a warning may be displayed to a user attempting to create a reserved tag, but the user may still be allowed to continue with the creation of the reserved tag after acknowledging the warning.

Any number of rules for the formation of tags may be enforced. In some embodiments, tags may be automatically generated for each ad placement identifying the account, channel, distribution, campaign, and/or ad group with which an ad placement is associated. For example, all tags created for ad placements associated with the marketing account for the Acme Corp. may be tagged with account_acme. For those ad placements that will be marketed in a particular channel, for example, through direct email marketing, the system may generate a tag such as channel_email. In other embodiments, the system may have instead or in addition generated the individual tags acme and email. It will be appreciated that the system may incorporate rules or hierarchical structure according to any business or marketing method known in the art, and the system may obtain information about those rules or structure through communication or integration with one or more external systems, such as a business enterprise systems or existing keyword management system.

Tags may also be generated according to certain brand or trade names appearing in the content of the ad placement. For example, a certain tag may be applied to all ad placements containing the name of the company placing the ad. A different tag may be applied to all ad placements containing the names of that company's competitors. These “brand tags” may be useful, for example, in generating bid recommendations for ad placements targeted at customers who perform searches on those brand names.

In some embodiments, the system may be configured to automatically generate tags upon the satisfaction of other conditions. For example, tags may be generated for all ad placements that were created during a particular time period, or before a particular point in time. Creating these tags would be useful for purposes of archiving, for example, so that older ad placements could be reviewed to determine their ongoing effectiveness or evaluated for removal or update. In some embodiments, the tags may indicate the year (e.g., 2010) or may alternately or in addition generate a general tag to indicate that the ad placement should be archived, e.g., archive. In still other embodiments, a tag may be generated for each ad placement, indicating the ad placement's creation date, a target deletion date, or other measurement for tracking the lifecycle of the ad placement. Such a tag could be generated with reference to the ad placement itself, to metadata stored about the ad placement, or any other data source.

In some embodiments, ad placements may be tagged according to their performance by reference to or calculation of performance metrics. In some embodiments, a particular performance metric may be calculated for each ad placement, either periodically or at the time the tagged placements are retrieved, and those ad placements may be tagged according to their performance relative to a particular threshold. For example, all ad placements having an ROI (return-on-investment) falling below a certain ratio may be tagged as underperforming, e.g., “low_performer.” In other embodiments, ad placements falling into some or all percentiles of performance for a particular performance metric may be tagged (e.g., bottom 25% among all ad placements In in terms of ROI). This would allow a user to take action on all ad placements meeting a particular performance condition by modifying the bid recommendations or strategy for those ad placements, removing or suspending those ad placements altogether, or investigating the reason for the performance level or identify characteristics common to those ad placements at that performance level.

In some embodiments, the content of the ad placement itself may be parsed to generate one or more tags based on that content. For example, a tag may be generated from each word in a text-based ad placement. Thus, an ad placement containing the text “Acme Widgets: $10” could cause the following tags to be automatically generated: acme, widgets, and $10. In some embodiments, it may be desirable to avoid creating tags for certain words in the ad placement that provide minimal marketing insight, for example, “the,” “a”, etc.

In related embodiments, the content of the ad placement itself may be parsed to generate one or more tags based on linguistic properties of the content. In these embodiments, one or more tags may be generated and applied to all ad placements containing a specific part of speech. In other embodiments, similar but non-identical words in a plurality of ad placements may be identified through use of a stemming algorithm, and those similar words may be tagged with a particular textual metadata tag. “Stemming” is the act of reducing a word to its stem, base, or root form. Various stemming algorithms are known in the art, for example, the Porter stemming algorithm, Lovins stemming algorithm, Lancaster stemming algorithm, and others algorithms or variations thereof.

In other embodiments, specific occurrences of a characteristic or trait of an ad placement may be identified, and a tag may be generated containing the name or other descriptor of the characteristic or trait. For example, upon identifying the term “$10,” or any other term containing “$” (dollar sign), the system may apply the tag price, or price_{—}10. As another example, for each ad placement containing an occurrence of a color name, a tag color may be generated. This may be useful for identifying all ad placements that describe a particular trait of a marketed product or service for further review or action. Other characteristics may be similarly identified, for example, product lines, accounts, channels, campaigns, pricing strategies (i.e., discounts, clearance sales, bundling of products), and tags generated appropriately. A data dictionary containing predefined examples of occurrences of a characteristic may be accessed, and the data dictionary may be configurable and/or able to receive updates.

In other embodiments, the system may receive data about one or more ad placements over a distributed computer network such as the Internet, and use that data to generate tags for those ad placements. Such tags could be highly useful for identifying the ways in which consumers interact with ad placements. For example, some search engines display sponsored advertising related to the keywords searched by a user of the search engine. In some embodiments, it may be possible to identify the search engine keywords entered by a consumer that resulted in a particular ad placement being displayed to that consumer. Those keywords may be delivered to the system over a distributed computer network, on a storage medium, or in any other way, and the keywords may then be formed into tags for application to those ad placements that were displayed as a result of those keywords. For example, it may be possible to determine that a particular ad placement was viewed on the GOOGLE search engine in response to a search on the keywords “cheap widgets” by, for example, the search engine identifying the keywords to the system over the Internet. The system may then generate one or more tags, for example google_cheap_widgets, or google_cheap and google_widgets, for that particular ad placement.

In other embodiments, tags may be generated according to search statistics or search reports for one or more search engines, for example, the GOOGLE search report. These reports may provide a ranked list of high-performing keywords for given criteria. In these embodiments, tags may be generated and applied to ad placements that would exhibit better performance or profitability if they were displayed in response to searches on those high-performing keywords.

Referring still to FIG. 3, in act 320, the tag is associated with one or more ad placements. As discussed with reference to the system above, this “tagging” of one or more ad placements may be performed in any number if ways. For example, in some embodiments the tag may be stored in a database along with an indicator of which ad placements are associated with it. In other embodiments, the tag may alternately or additionally be “embedded” in the ad placement. For example, if the ad placement is stored in a file, the characters making up the tag may be inserted into the file, or stored as metadata information with the file, for example, in a companion file associated with the ad placement file. As another example, the ad placement may be stored in XML or other markup format, and the tag may be inserted into the data, for example, as an XML element. It will be appreciated that there are many ways of associating one or more tags with one or more ad placements, and the illustrative examples given here are not intended to limit the scope of this disclosure in any way.

In some embodiments, the system may allow bidding tags, which are a special type of tag wherein the system may be configured to enforce certain rules for tagging ad placements with bidding tags. As discussed above, it may be desirable in several embodiments to perform a given action on all ad placements associated with a particular tag. However, when that action interacts with the ad placement in a particular way, it may be desirable to limit the number or type of actions that act on the ad placement. In other words, there may be one or more classes of “exclusive actions” where it may be desirable to ensure that less than all of the actions (for example, only one action) from the class of exclusive actions should be performed within a certain time period, or where the actions should be performed in a particular order. In some embodiments, these exclusive actions may only be allowed to be performed on those ad placements associated with bidding tags. In some embodiments, when one or more bidding tags associated with a given ad placement (and/or an attempt is made to associate one or more bidding tags with a given ad placement) the relative priority of the set of bidding tags may be calculated or otherwise ascertained.

For example, an ad placement may be tagged by the bidding tag bid_inc_{—}15. This tag may cause an algorithm to be applied in step 330 (discussed below) that increases the bid amount for all ad placements associated with that bidding tag bid_inc_{—}15 by 15%. However, a user may attempt to also tag the same ad placement with the bidding tag bid_inc_{—}20, which is associated with an algorithm that increases the bid amount for all ad placements tagged with bid_inc_{—}20 by 20%. It may be undesirable to carry out both the 15% and the 20% increases, as this would actually increase the bid amount by 38%.

Therefore, in act 320 of FIG. 3, in several embodiments, the number of bidding tags allowed to be associated with a given ad placement may be limited. In some embodiments, the system may allow at most one bidding tag to be associated with a particular ad placement at any given time. For example, if a user attempts to tag an ad placement with a second bidding tag when the ad placement is already associated with a first bidding tag, the system may prevent the second bidding tag from being associated with the ad placement. Alternatively, the relative priority among multiple bidding tags may be determined. In some embodiments, the higher priority bidding tag may be the only bidding tag associated with a given ad placement. For example, if a user attempts to tag an ad placement with a bidding tag when that ad placement is already associated with a different bidding tag, the system may cause only the bidding tag with the higher priority of the two to be associated with the ad placement, and may dissolve the association between the lesser priority bidding tag and the ad placement if necessary.

The priority of an individual bidding tag may be determined in any number of ways. In some embodiments, the priority may be determined automatically by the system based on any configurable rule, for example, by parsing the bidding tag for certain keywords (e.g., “purge,” “delete,” “increase”), or by assigning priorities in chronological order (e.g., later-created bidding tags may be presumed to have a higher priority than earlier-created bidding tags, or vice versa). In other embodiments, the bidding tags may be assigned priorities by the user, either at the time of creation of the bidding tag or at the earliest instance of two bidding tags being assigned to a particular ad placement. Other techniques for assigning relative priorities to bidding tags may also be employed, for example, alphabetical order.

In other embodiments, several bidding tags may be allowed to be associated with a given ad placement, and the actions associated with the bidding tags may be applied in descending order of the priority of the bidding tag.

In still other embodiments, “cross channel” tagging may be allowed. In other words, a tag may be applied to one or more ad placements based on a metric associated with one or more ad placements in a different channel. These tags could be used to help identify ad placements having shared characteristics across several channels, and would allow a user to take an action on ad placements in one channel based on the performance or other attribute of the ad placements having the shared characteristic in other channels. For example, it may be determined that organic search keywords touting the color of a product have experienced a relatively high “clicks per impression.” In that case, a bidding tag may be applied to all corresponding paid ad placements containing the color of the product. The bidding tag may indicate that, based upon the performance of the organic search keywords, the bid amount for corresponding or similar ad placements in other channels should be modified.

In act 330, one or more actions may be performed on every ad placement associated with the tag. The actions performed on the ad placements may include, for example, generating a report, graph, or chart about some characteristic or historical performance measure of the ad to placements; downloading information or bid recommendations for those ad placements for backup, offline use, or use on another system; making changes to or entering bid recommendations or bid strategies; creating an alert to notify one or more users and/or automatically take action when some metric describing the ad placements, either alone in aggregate, exceeds or falls below a certain defined threshold; or adding additional tags.

### User Interfaces

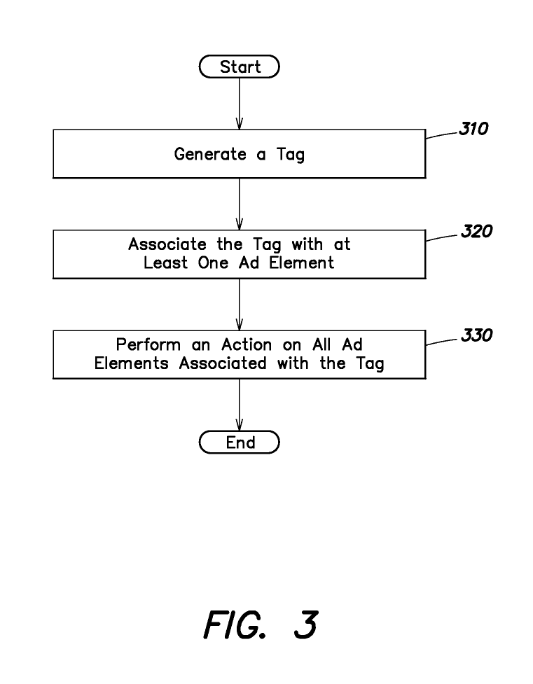

FIG. 4 shows an exemplary tagging interface 400 for manually associating tags with ad placements in accordance with one aspect of the present invention. A tag list 410 may be displayed, and may be populated with existing and/or predefined tags. The tag list 410 may allow a user to select one or more tags at a time through the use of a mouse, keyboard, or other input device. In some embodiments, the tag list 410 may display all of the tags that have ever been created and are currently stored in the system. In other embodiments, the tag list 410 may display only those tags currently associated with at least one ad placement. The tag list may display one tag per line of text, or may display the tags in any other method known in the art, including a hierarchy or “tag cloud” visually depicting the tags, with the appearance of the tags varying by font size, weight, and/or color according to certain factors. For example, the tag cloud may display more important or more frequently used tags differently. As a further example, the tag cloud may display tags associated with different users, accounts, channels, or ad groups differently in order to distinguish them. Other techniques for differentiating among tags may also be used.

An ad placement list 420 may also be provided to display one or more ad placements currently in existence on the system. In some embodiments, the ad placement list 420 may be populated with all ad placements in the system. In other embodiments, the ad placement list 420 may only display certain ad placements depending on the role and privilege level of the user. For example, a system administrator may be allowed to view all ad placements in the system, whereas an account manager may be allowed to view all ad placements in the account. The ad placement list 420 may allow a user to select one or more ad placements through the use of a mouse, keyboard, or other input device.

Referring still to FIG. 4, a tag input field 430 may be provided and configured to receive text input from the user. In the event that the user wishes to create a tag not already existing in the ad placement list 410, the user can enter text in the tag input field 430 and, in accordance with the concept of restricted tags and bidding tags as described above, the tag 430 may be created.

An apply button 440 may be provided so that, after a user has selected one or more tags from the tag list 410 or entered text in the tag input field 430, and selected one or more ad placements from the ad placement list 420, clicking the apply button 440 will associate the selected tags with the ad placements (i.e., tag the ad placements with the selected tags). A clear button 450 may also be provided such that, when it is clicked, any selections made in the tag list 410 and the ad placement list 420 are cleared by unselecting the selected items.

Various techniques may be employed for indicating that an ad placement in the ad placement list 420 has been tagged with one or more tags from the tag list 410. For example, when an ad placement in the ad placement list 420 is highlighted, all tags in the tag list 410 that are associated with the ad placement may appear in bold or other distinctive font or color. In some embodiments, a line may be displayed connecting the ad placement to all associated tags in the tag list 410. In other embodiments, all of the tags associated with a particular ad placement may be listed in the interface when the ad placement is selected.

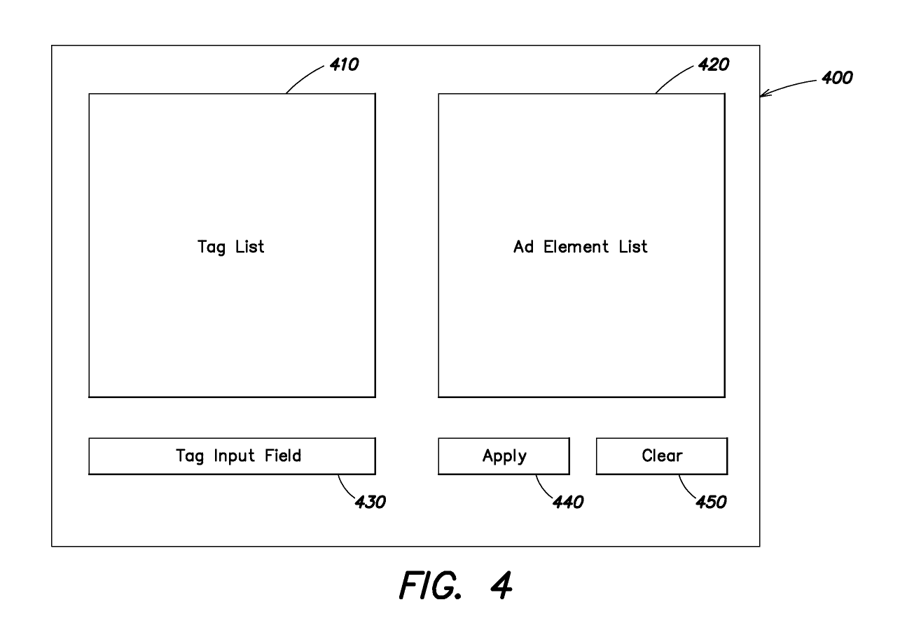

FIG. 5 shows an exemplary reporting interface 500 for aggregating and reporting the performance of ad placements associated with one or more tags in accordance with one aspect of the invention. The reporting interface 500 may display, for each tag 510, one or more metrics or performance measurements 520 calculated for all ad placements associated with the tag 510. For example, the reporting interface 500 may display metrics such as impressions, clicks, cost, conversions, revenue, return on investment, and/or profitability for all ad placements associated with each tag 510. Each metric may be displayed in a separate column, and the columns may provide functionality for sorting the tags 510 according to the metric displayed in the column The sorting may be performed in either ascending or descending order. In several embodiments, the order and appearance of the columns may be configurable. In some embodiments, functionality may be provided to define custom metrics.

In some embodiments, the reporting interface 500 may further provide functionality for expanding or collapsing the tags 510 in order to view the data at a desired level of granularity. For example, each tag 510 may have a control 512 that allows the user to toggle between an expanded view and a collapsed view, i.e., the metric data may be expanded to show the metrics for each individual ad placement tagged by the tag 510. In some embodiments, expanding/collapsing functionality may be provided at the account, channel, distribution, campaign, and/or ad group level, i.e., the tags 510 themselves can be aggregated by account, channel, and/or ad group.

It will be appreciated that the reporting interface 510 may incorporate any techniques known in the art for reporting data, including exporting data to Excel or other data management tool, generating graphs, or other functionality.

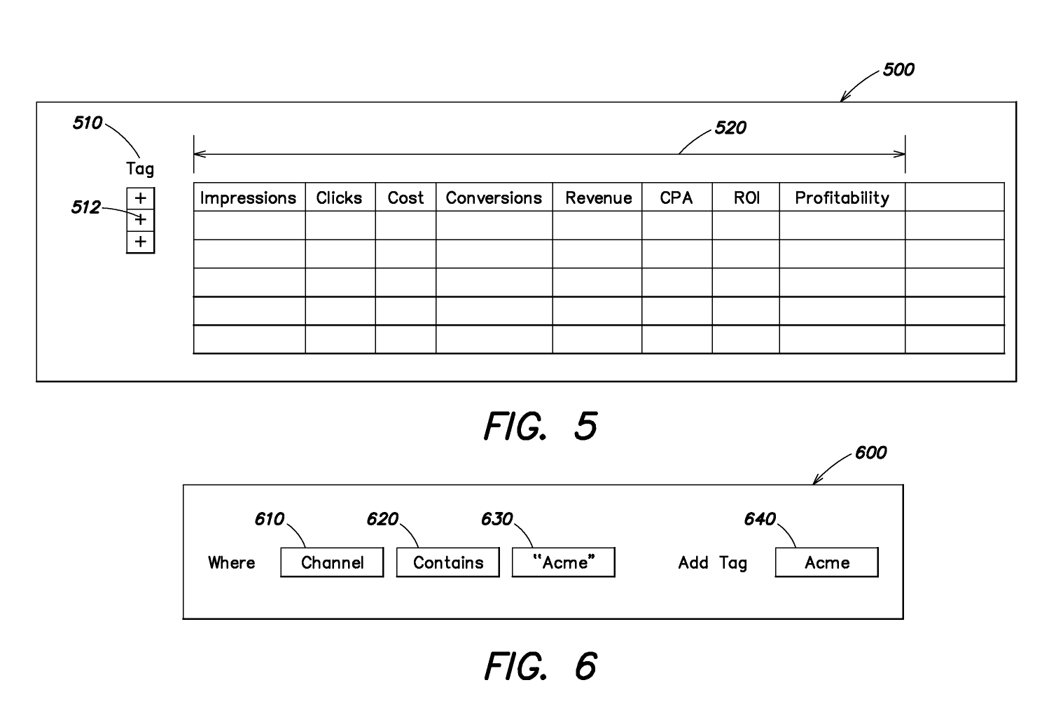

FIG. 6 depicts an exemplary rule interface 600 that provides a user with the ability to design rules for automatically tagging ad placements based on ad characteristics, ad content, existing tags, accounts, channels, ad groups, performance metrics, or other aspects of the ad placement. The interface allows users to define rules with pull-down selection controls and/or text input boxes. In some embodiments, the rules may be defined in query format where the user defines parameters for several placements of the query. For example, in the query “where account contains Acme, add tag Acme,” the user may define the terms of the query through interaction with a placement control 610, a relationship control 620, a search string control 630, and a tag input control 640. The placement control 610 allows the user to define an aspect of the ad placement (in the previous example, the selected aspect is the name of the account.) The relationship control 620 allows the user to define the relationship between the placement control 610 and the search string control 630 (in the previous example, the selected relationship is “contains.”) The search string control 630 allows the user to define a search string having the selected relationship with the selected aspect (in the previous example, the search string is “Acme”.) The tag input control 640 allows the user to define a tag to be applied to any ad placements satisfying the query (in the previous example, the tag is “Acme”.)

The placement control 610, relationship control 620, search string control 630, and tag input control 640 may be implemented to employ predefined parameters and/or user-input parameters. In some embodiments, the placement control 610 and the relationship control 620 may provide the user a finite list of items to select from. For example, the placement control 610 may be a pull-down list including aspects of the ad placement such as account, channel, distribution, campaign, ad group, existing tags associated with the ad placement, ad content, or any number of performance metrics. The relationship control 620 may also be a pull-down list containing such relationships as equal to, not equal to, contains, does not contain, less than, greater than, less than or equal to, greater than or equal to, begins with, contains word stem, semantically related to, or any other relationship. The search string control 630 may be a text input box that receives user input from a keyboard and allows wildcards as known in the art of searching text. The tag input control 640 may also be a text input box that receives user input to from a keyboard, and may allow the user to add several tags separated by a delimiter such as a space or semicolon. The search string control 630 and/or the tag input control 640 may include some form of text auto-completion, for example, type-ahead functionality wherein text entered in the text input control 640 is compared with existing tags and, if any matches of the beginning of the string are found, the existing tag appears in the box for the user to either select or continue typing a new tag.

In some embodiments, the rule interface 600 may provide functionality to generate compound queries by combining several single queries through a logical union or intersection.

Ad placements may be tagged according to the queries defined in the rule interface 600 immediately upon creation of the ad placement, on a periodic basis where the system scans the existing ad placements to determine if further tagging is necessary, and/or as a result of manually starting the automatic tagging process.

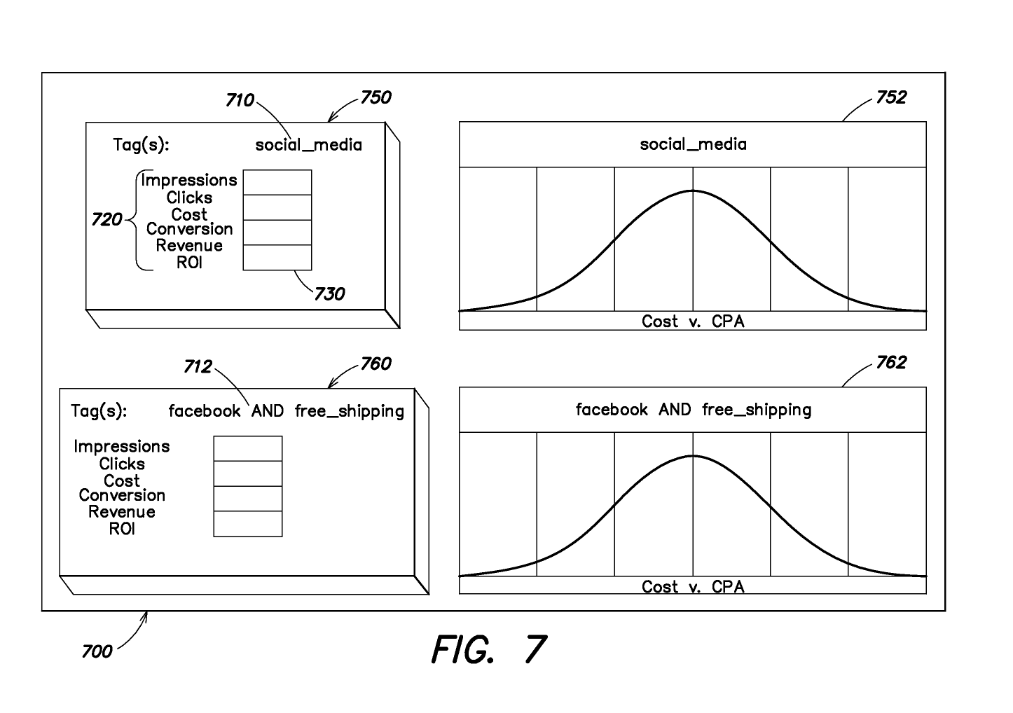

FIG. 7 depicts an exemplary dashboard interface 700 for viewing aggregated statistics, performance analyses, and other data for the advertising placements associated with one or more tags. Data about the advertising placement associated with one or more tags may be arranged into report windows 750, 760, which may be configured, added, moved, or removed from the dashboard view according to a default scheme or user preferences. The report windows 750, 760 may thus provide standard metrics about different advertising placements, allowing for a literal side-by-side comparison of the advertising placements associated with different tags.

Each report window 750, 760 may include a tag control 710 allowing the user to enter or select a tag previously associated with one or more advertising placements. In response to the selection, the dashboard interface 700 may perform statistical or other analysis and display data 730 for one or more aggregate performance metrics 720 for those advertising placements associated with the tag. The performance metrics may include, for example, number of impressions, number of clicks, number of conversions, cost, revenue, and ROI for the advertising placements. Other data may be displayed, such as the number of advertising placements in the set for which performance metrics are generated, the age of the tag, and any other statistics known in the art for providing information about the tag or the advertising placements associated with the tag. The dashboard interface 700 may be configurable by the user such that the data 730 may be calculated over the lifetime of the advertising placements, or else may be calculated for a discrete time period, such as a week, year, month, year to date, or month to date, or user-defined date range.

The dashboard interface 700 may optionally include a configurable chart 752, 762 for some of the report windows 750, 760. The chart 752, 762 may allow the user to graph one or more metrics against other metrics or over a certain period of time.

In some embodiments, the dashboard interface 700 may allow for selection of advertising placements using operators on one or more tags. Various operations, such as union (tag1 AND tag2), intersection (tag1 OR tag2), complement (NOT tag1), or other operations may be performed in selecting advertising placements. For example, as can be seen in FIG. 7, a compound tag control 712 may allow the user to select advertising placements that are associated with both the tag facebook and the tag free_shipping. It will be appreciated that the example of two tags is shown for illustrative purposes only, and any number of tags may be used in forming a compound selection.

The tagging interface 400, the reporting interface 500, the rule interface 600, and the dashboard interface 700 are provided for exemplary purposes, and different configurations of data may be displayed and different statistical methods may be performed in other embodiments. Further, some or all of the interfaces may be incorporated into a software suite, such as a bid recommendation software package. The bid recommendation software package may be configured to act automatically upon the occurrence of some event in relation to the advertising placements associated with one or more tags. For example, as described above, the system may be configured to tag all low performing advertising placements with the tag low_performer. It may be desirable to allow for the bid recommendation software to be configured to automatically (i.e., without human interaction) place new lower bids for those advertising placements. The system and methods described herein may be integrated in systems for managing advertising placements in any number of ways.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several placements.

Where technical features in the drawings, detailed description or any claim are followed by references signs, the reference signs have been included for the sole purpose of increasing the intelligibility of the drawings, detailed description, and claims Accordingly, neither the reference signs nor their absence are intended to have any limiting effect on the scope of any claim placements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A method for managing online advertising placements, comprising acts of:
associating a plurality of textual metadata tags with at least one advertising placement in a plurality of advertising placements; and
generating a bid recommendation for the at least one advertising placement associated with the plurality of textual metadata tags.

2. The method of claim 1, further comprising an act of determining a relative priority of each to textual metadata tag in the plurality of textual metadata tags, wherein the act of generating a bid recommendation is performed with reference to the relative priority.

3. The method of claim 1, further comprising an act of permitting the at least one advertising placement to be associated with at most one exclusive textual metadata tag.

4. The method of claim 1, further comprising an act of calculating a performance metric for the at least one advertising placement, wherein the act of generating a bid recommendation is carried out with reference to the performance metric.

5. The method of claim 1, further comprising acts of:
receiving user input from a user; and
forming the user input into at least one textual metadata tag.

6. The method of claim 5, wherein the act of forming the user input into at least one textual metadata tag comprises the act of forming, responsive to the user input satisfying at least one predetermined syntax rule, the user input into at least one textual metadata tag.

7. The method of claim 1, wherein the act of associating the plurality of textual metadata tags with at least one advertising placement in a plurality of advertising placements includes acts of:
associating at least one selection condition with a textual metadata tag; and
associating, responsive to a selection of the textual metadata tag, the textual metadata tag with at least one advertising placement satisfying the selection condition.

8. The method of claim 7, wherein the selection condition is a selection query.

9. The method of claim 1, wherein the bid recommendation is generated based on at least one of the plurality of textual metadata tags.

10. The method of claim 1, wherein at least one of the plurality of textual metadata tags indicates a characteristic of the at least one advertising placement.

11. The method of claim 1, wherein at least one of the plurality of textual metadata tags indicates a characteristic of a product advertised by the at least one advertising placement.

12. The method of claim 1, wherein at least one of the plurality of textual metadata tags indicates a characteristic of a transaction involving a product advertised by the at least one advertising placement.

13. The method of claim 12, wherein the characteristic of the transaction includes the advertised price of the product.

14. The method of claim 12, wherein the characteristic of the transaction includes the advertised shipping cost of the product.

15. The method of claim 1, wherein at least one of the plurality of textual metadata tags indicates a URL of an advertising placement.

16. The method of claim 1, further comprising an act of receiving at least one of the plurality of textual metadata tags over a distributed computer system.

17. The method of claim 16, wherein at least one of the textual metadata tags indicates a search keyword used in a search engine search that resulted in the at least one advertising placement to be displayed.

18. The method of claim 16, wherein the at least one textual metadata tag is generated by a user of the Internet.

19. A method for managing online advertising placements, comprising acts of:
associating a plurality of textual metadata tags with at least one advertising placement in a plurality of advertising placements;
retrieving performance metrics about the plurality of advertising placements; and
evaluating a performance of the at least one advertising placement associated with the plurality of textual metadata tags.

20. The method of claim 19, wherein at least one of the plurality of textual metadata tags indicates a characteristic of the at least one advertising placement.

21. The method of claim 19, wherein at least one of the plurality of textual metadata tags indicates a characteristic of a product advertised by the at least one advertising placement.

22. The method of claim 19, wherein at least one of the plurality of textual metadata tags indicates a characteristic of a transaction involving a product advertised by the at least one advertising placement.

23. The method of claim 22, wherein the characteristic of the transaction includes the advertised price of the product.

24. The method of claim 22, wherein the characteristic of the transaction includes the advertised shipping cost of the product.

25. The method of claim 19, wherein at least one of the plurality of textual metadata tags indicates a URL of an advertising placement.

26. The method of claim 19, further comprising the act of receiving at least one of the plurality of textual metadata tags over a distributed computer system.

27. The method of claim 26, wherein at least one of the textual metadata tags indicates a search keyword used in a search engine search that resulted in the at least one advertising placement to be displayed.

28. The method of claim 26, wherein the at least one textual metadata tag is generated by a user of the Internet.

29. The method of claim 19, further comprising acts of:
receiving user input from a user; and
forming the user input into at least one textual metadata tag.

30. The method of claim 19, wherein the act of associating the plurality of textual metadata tags with at least one advertising placement in a plurality of advertising placements includes acts of:
associating at least one selection condition with a textual metadata tag; and
associating, responsive to a selection of the textual metadata tag, the textual metadata tag with at least one advertising placement satisfying the selection condition.

31. The method of claim 19, further comprising acts of:
generating a report on the performance of the at least one advertising placement associated with the plurality of textual metadata tags; and
providing the report to a user.

32. The method of claim 19, further comprising the act of determining a relative performance of each of the at least one advertising placements associated with the plurality of textual metadata tags.

33. The method of claim 19, further comprising acts of:
receiving user input from a user; and
forming the user input into at least one textual metadata tag.

34. The method of claim 33, wherein the act of forming the user input into at least one textual metadata tag comprises the act of forming, responsive to the user input satisfying at least one predetermined syntax rule, the user input into at least one textual metadata tag.

35. A computer-readable medium comprising computer-executable instructions that, when executed on a processor of a server, perform a method for managing online advertising placements, comprising acts of:
associating a plurality of textual metadata tags with at least one advertising placement in a plurality of advertising placements; and
generating a bid recommendation for the at least one advertising placement associated with the plurality of textual metadata tags.

36. The computer-readable medium of claim 35, wherein the method further comprises an act of permitting the at least one advertising placement to be associated with at most one exclusive textual metadata tag.

37. The computer-readable medium of claim 35, wherein the method further comprises an act of calculating a performance metric for the at least one advertising placement, wherein the act of generating a bid recommendation is carried out with reference to the performance metric.

38. A system comprising:
a tag database configured to store a plurality of textual metadata tags and a placement identifier identifying at least one advertising placement associated with the plurality of textual metadata tags;
a placement database configured to store information about at least one advertising placement;
a tagging engine configured to generate the plurality of textual metadata tags and store the plurality of textual metadata tags in the tag database.

39. The system of claim 38 further comprising a user interface configured to receive user input.

40. The system of claim 39, wherein the user input is text used to generate at least one textual metadata tag.

41. The system of claim 38, further comprising a reporting interface configured to calculate and display performance metrics relating to the plurality of textual metadata tags and the at least one advertising placement.

42. A method for managing online advertising placements, comprising acts of:
evaluating a performance of a first advertising placement;
identifying at least one second advertising placement having at least one characteristic in common with the first advertising placement; and
associating a textual metadata tag with the second advertising placement.

43. The method of claim 42, wherein the second advertising placement is of a different format than the first advertising placement.
